(19) United States
(12) Patent Application Publication
(10) Pub. No.: US 2009/0021548 A1
(43) Pub. Date: Jan. 22, 2009

(54) INKJET PRINTING APPARATUS AND METHOD FOR PERFORMING MAINTENANCE ON INKJET PRINTING APPARATUS

(75) Inventors: Kazuo Suzuki, Yokohama-shi (JP); Daigoro Kanematsu, Yokohama-shi (JP); Satoshi Hayashi, Yokohama-shi (JP); Taku Yokozawa, Yokohama-shi (JP); Yuhei Oikawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/174,376

(22) Filed: Jul. 16, 2008

(30) Foreign Application Priority Data
Jul. 18, 2007 (JP) 2007-187396

(51) Int. Cl. B41J 29/38

(52) U.S. Cl. 347/14

(57) ABSTRACT

An inkjet printing apparatus, a maintenance method and an inkjet printing system which are capable of precisely calculating the amount of satellites or ink mist generated and replacing a collecting mechanism at most appropriate time. The inkjet printing apparatus has a wind-powered collecting mechanism collecting generated sub-droplets such as satellites or ink mist, and head temperature sensors for obtaining temperature information of the print head. The CPU calculates the amount of sub-droplets generated on the basis of printing conditions including the detected temperature information of the print head. The CPU determines whether the replacement of the wind-powered collecting mechanism is necessary on the basis of the calculated amount of sub-droplets generated.

### BACKGROUND OF THE INVENTION

1. Field of the Invention

This invention relates to an inkjet printing apparatus and a method of performing maintenance on an inkjet printing apparatus, and particularly, to an inkjet printing apparatus having means for collecting sub-droplets resulting from droplet ejection from the print head, and a method of performing maintenance on the inkjet printing apparatus.

2. Description of the Related Art

Recently, along with the popularization of the Internet, printing apparatuses having the multiple functions of a printing apparatus, a copying machine, a facsimile machine and the like have been widely employed as the output equipment of a workstation or a complex electronic equipment including computers, word processors and the like in offices, homes or the like. Such widespread printing apparatuses are based on an electrophotographic method, an inkjet method and the like.

Among them, many inkjet printing apparatus employing the inkjet method for printing adopt the technique of using an electrothermal transducing element or an electromechanical transducing element to eject droplets from a nozzle such that the ejected droplets impact on the printing medium to form an image. Such an inkjet printing apparatus has the advantage of the capability prints on various types of printing media, such as fabrics, corrugated boards, earthenware and metal, as well as paper, OHP sheets and films. In addition, the inkjet printing apparatus has the advantage of the capability of printing not only on a flat printing medium but also a printing medium with an uneven face, a curved face, an edge and the like.

In particular, the inkjet printing apparatus has the advantages of facilitating a reduction in size of the print head and of a low noise level because of being of the non-impact type. In addition, the inkjet printing apparatus has other advantages, for example, of easily printing a color image by use of multicolor inks, of having low running costs, and of the capability of printing a high-definition image at high speed.

Further, in an inkjet printing apparatus equipped with an electrothermal transducer to use thermal energy for the ink ejection, the print head for ejecting droplets can be made more compact (reduced in size). For manufacturing the print head used in this type of inkjet printing apparatus, an electrothermal transducer, electrodes, liquid channel walls, a top plate and the like are formed on the substrate through a semiconductor producing process including etching, vapor deposition, sputtering and the like. Thus, a print head having a high-density liquid-channel array (ejection port array) can be manufactured.

Because the inkjet printing apparatus has a lot of advantages as described above, it is generally widely used. The inkjet printing apparatus is widely used as a printing apparatus not only by individual users but also by corporate users.

However, in some inkjet printing apparatus, when an ink drop is ejected from the print head, a droplet which is smaller in size than the main droplet may possibly be ejected simultaneously with the main droplet to a position different from the impacting position of the main droplet. If the smaller droplet ejected together with the main droplet impacts on the printing medium, a dot, different from main drop, which is smaller in size than that formed by the main droplet is formed on the portion of the printing medium close to the portion on which the main droplet impacts, resulting in a reduction in image quality. Such a smaller droplet ejected together with the main droplet is called “a satellite”.

Misty ink drops which are even smaller size than that of the ink drop resulting in the satellite may possibly occur. The misty ink drops are called an ink mist (alternatively, simply “mist”). Upon the ink ejection, the ink mist is carried by the air current around the print head and floats in the air within the apparatus. As a result, the mist may possibly stain the printing apparatus. Thus, the printing apparatus may be contaminated. Alternatively, the mist may possibly adhere to the printing medium, resulting in a reduction in image quality. Also, if the satellite or the ink mist impact on the printing medium, image noise occurs or inconsistent density or a change in color may occur on a halftone image. In order to inhibit the satellite or the ink mist from reducing the image quality, the adhesion of the satellite and the ink mist to the printing medium is required to be reduced by being removed from the image area or by being collected.

Some approaches for removing or collecting the satellite or ink mist produced in the inkjet printing apparatus as described above have been proposed.

Japanese Patent Laid-Open No. H06-166173 discloses an inkjet printing apparatus in which a carriage body is equipped with a blower fan so that air is sent from the downstream side of the printing area, that is, from the printed area, toward the upstream side, that is, toward the not-yet-printed area. By sending air through the space between the print head and the printing medium in this manner, the ink mist flying inside the inkjet printing apparatus is removed while the print head and the printing medium are being cooled.

Japanese Patent Laid-Open No. H11-138777 discloses an inkjet printing apparatus equipped with an inducing blower fan and a suction fan. These fans produce a current of air flowing from the upstream side toward the downstream side in the direction of feeding the printing medium, in order to move the flying ink mist involved with the air flow to be sucked into the inlet port of the suction fan for collection of the generated ink mist. Thus, the ink mist is precluded from adhering to the housing or each component or the feeding mechanism. In this manner, the ink mist is inhibited from flying inside the inkjet printing apparatus.

Japanese Patent Laid-Open No. H11-348249 discloses an inkjet printing apparatus comprising a powered fan provided for sucking the generated ink mist, and a tank provided behind the powered fan for collecting the sucked ink mist. The powered fan is located in the vicinity of to the position in which the print head and the printing medium face each other. When the ink ejection speed is high, the inkjet printing apparatus operates the powered fan for removing the mist. On the other hand, when the ink ejection speed is low, the inkjet printing apparatus stops the powered fan. In this manner, when the ink is ejected at high speed and a large amount of ink mist occurs, the flying ink mist is removed and when the ink ejection speed is low and a small amount of ink mist occurs, the power consumption is reduced.

The inkjet printing apparatus disclosed in Japanese Patent Laid-Open No. 2006-192704 previously determines whether the amount of ink mist occurring is large or small, and controls the velocity and volume of the wind in accordance with the determined amount of ink mist. The inkjet printing apparatus disclosed in Japanese Patent Laid-Open No. 2006-192704 comprises a wind-powered collecting mechanism having a fan for sucking air from the vicinity of the print head and sending the sucked air to the outside of the printing apparatus, and a duct for controlling the air flow from the fan. The wind-powered collecting mechanism generates an air flow inside the printing apparatus in order to collect the ink mist and/or satellite flying in the air inside the inkjet printing apparatus. Then, the inkjet printing apparatus controls the driving of the fan in accordance with the distance between the print head and the platen, the number of print scans performed on the same printing area, and the type of ejected ink for the control of the velocity and volume of the wind sent from the fan.

Regarding the distance between the print head and the platen, the longer the distance between the printing medium and the ejection-port face of the print head in which the ejection ports are formed, the greater the amount of satellites and ink mist generated. Regarding the number of print scans on the same printing area, the lower the number of print scans, the larger the amount of ink ejected each time. Because of this, the amount of satellite or ink mist increases. It is known that if a large amount of ink is ejected each time, this produces a current of air flowing from the print head toward the printing medium, and also the current of air so produced kicks back, which results in an upward current of air over the printing medium. Accordingly, very minute ink drops ride the upward air current and float in the air, resulting in a further increase in the amount of satellite or ink mist occurring. The amount of satellite or ink mist varies from type to type of ejected ink. Hence, the driving of the fan is controlled in accordance with these factors for the control of the velocity and volume of the wind.

However, even if the velocity and volume of the wind are controlled in accordance with the amount of satellite or ink mist generated as described above, the factors used in this prediction are inadequate. Precise predictions about the amount of satellite or ink mist may possibly not be made. That is, because the factors used for the predictions about the amount of satellite or ink mist are inadequate, the actual amount of satellite or ink mist differs from the predicted amount by variations in factors other than the factors used for the predictions. As a result, a wind may possibly not be supplied at a suitable velocity and in a suitable volume for removing the satellites or ink mist. Since the calculations in the predictions are not precisely made from a sufficient amount of information, the amount of satellite or ink mist collected may possibly not be precisely estimated.

The aforementioned inkjet printing apparatus controls the wind velocity and volume in accordance with variations in the amount of satellites or ink mist resulting from the print operation, but does not calculate the amount of satellites or ink mist produced by the printing operation. Also, the inkjet printing apparatus does not detect the amount of satellites or ink mist produced until the last printing operation. Accordingly, the inkjet printing apparatus does not detect the amount of satellites or ink mist collected and stored by a wind-powered collecting mechanism at the time.

As a result, it is impossible to precisely detect the remaining capacity of the wind-powered collecting mechanism for collecting and holding satellites or ink mist after that time. For example, if the amount of satellites or ink mists generated is estimated to be extremely low, the inkjet printing apparatus is continuously used without part replacement, so as to allow the misty satellites or ink mist adhering to the wind-powered collecting mechanism to aggregate into drops. Then, the drops of the satellites or ink mist leak from the wind-powered collecting mechanism, leading to the likelihood of the leaking drop soiling the user or causing a failure of the inkjet printing apparatus. On the other hand, if the amount of satellites or ink mist generated to be extremely high, the maintenance cost of the inkjet printing apparatus may possibly be increased by replacing the parts unnecessarily early.

### SUMMARY OF THE INVENTION

In light of the foregoing circumstances, an object of the present invention is to provide an inkjet printing apparatus capable of precisely calculating the amount of satellites or ink mist being generated to replace a collecting mechanism at the most appropriate time, and a method for performing maintenance on the inkjet printing apparatus.

According to a first aspect of the present invention, an inkjet printing apparatus using print heads for ejecting liquid droplets to a printing medium for printing comprises: a sub-droplet collecting portion that collects sub-droplets each having a smaller liquid volume than that of a main droplet in each of the liquid droplet and produced by the ejection; a temperature obtaining mean that obtains temperature information of the print heads; a sub-droplet amount calculating mean that calculates the amount of sub-droplets occurring on the basis of printing conditions including the temperature information of the print heads; and a replacement necessity determining mean that determines whether or not the sub-droplet collecting portion is replaced, on the basis of the amount of sub-droplets occurring which has been calculated by the sub-droplet amount calculating mean.

According to a second aspect of the present invention, an inkjet printing apparatus using print heads for ejecting liquid droplets from ejection ports to a printing medium for printing comprises: a sub-droplet collecting portion that collects sub-droplets each having a smaller liquid volume than that of a main droplet in each of the liquid droplets and produced by the ejection; a sub-droplet amount calculating mean that calculates the amount of sub-droplets occurring on the basis of printing conditions including a shape of the ejection ports of the print heads; and a replacement necessity determining mean that determines whether or not the sub-droplet collecting portion is replaced, on the basis of the amount of sub-droplets occurring which has been calculated by the sub-droplet amount calculating mean.

According to a third aspect of the present invention, an inkjet printing apparatus using print heads for ejecting liquid droplets to a printing medium from a plurality of ejection port rows of ejection ports for printing comprises: a sub-droplet collecting portion that collects sub-droplets each having a smaller liquid volume than that of a main droplet in each of the liquid droplets and produced by the ejection; a sub-droplet amount calculating mean that calculates the amount of sub-droplets occurring on the basis of printing conditions including order of ejecting the liquid droplet from the ejection ports in the ejection port rows; and a replacement necessity determining mean that determines whether or not the sub-droplet collecting portion is replaced, on the basis of the amount of sub-droplets occurring which has been calculated by the sub-droplet amount calculating mean.

According to a fourth aspect of the present invention, a method of performing maintenance on an inkjet printing apparatus using print heads for ejecting liquid droplets to a printing medium for printing comprises: a process of collecting sub-droplets each having a smaller liquid volume than that of a main droplet in each of the liquid droplets and produced by the ejection; a temperature obtaining process for obtaining temperature information of the print heads; a sub-droplet amount calculating mean for calculating the amount of sub-droplets occurring on the basis of printing conditions including the temperature information of the print heads; and a replacement necessity determining process for determining whether or not a replacement of a sub-droplet collecting portion for collecting the sub-droplets is necessary in accordance with the amount of sub-droplets collected of the calculated sub-droplets.

According to a fifth aspect of the present invention, a method of performing maintenance on an inkjet printing apparatus using print heads for ejecting liquid droplets to a printing medium from ejection ports for printing comprises: a process of collecting sub-droplets each having a smaller liquid volume than that of a main droplet in each of the liquid droplets and produced by the ejection; a sub-droplet amount calculating mean for calculating the amount of sub-droplets occurring on the basis of printing conditions including a shape of the ejection ports of the print heads; and a replacement necessity determining process for determining whether or not a replacement of a sub-droplet collecting portion for collecting the sub-droplets is necessary in accordance with the amount of sub-droplets collected of the calculated sub-droplets.

According to a sixth aspect of the present invention, a method of performing maintenance on an inkjet printing apparatus using print heads for ejecting liquid droplets to a printing medium from ejection port rows of ejection ports for printing comprises: a process for collecting sub-droplets each having a smaller liquid volume than that of a main droplet in each of the liquid droplets and produced by the ejection; a sub-droplet amount calculating process for calculating the amount of sub-droplets occurring on the basis of printing conditions including order of ejecting the liquid droplet from the ejection ports in the ejection port rows; and a replacement necessity determining process for determining whether or not a replacement of a sub-droplet collecting portion for collecting the sub-droplets is necessary in accordance with the amount of sub-droplets collected of the calculated sub-droplets.

According to the present invention, since the amount of sub-droplets generated in the printing operation can be precisely calculated, the amount of sub-droplets held in the sub-droplet collecting portion for collecting the sub-droplets is precisely calculated. Accordingly, it is possible to replace the sub-droplet collecting portion at the most appropriate time on the basis of this calculation.

Further features of the present invention will become apparent from the following description of exemplary embodiments (with reference to the attached drawings).

### BRIEF DESCRIPTION OF THE DRAWINGS

FIG. 1 is a plan view of an inkjet printing apparatus according to a first embodiment of the present invention;

FIG. 2A is a sectional view illustrating an essential part of the inkjet printing apparatus in FIG. 1, and

FIG. 2B is an enlarged front view of the fan used in a mechanism for collecting sub-droplets shown in FIG. 2A;

FIG. 3 is a perspective view illustrating another type of fan used in the sub-droplet collecting portion shown in FIG. 2A;

FIG. 4 is a plan view illustrating a print head in the inkjet printing apparatus shown in FIG. 2A;

FIG. 5 is a block diagram illustrating the configuration of a control system circuit in the inkjet printing apparatus shown in FIG. 2A;

FIG. 6 is a table showing the relationship between the distance from the print head to the platen and the coefficient of the gap between the print head and the platen when calculating the amount of sub-droplets collected in the inkjet printing apparatus shown in FIG. 2A;

FIG. 7 is a table showing the relationship between the temperature of the print head and the temperature coefficient when the amount of sub-droplets collected in the inkjet printing apparatus shown in FIG. 2A;

FIG. 8 is a graph showing the relationship between the amount of ink mist generated and the temperature of the print head in the inkjet printing apparatus shown in FIG. 2A, as measured through experiments conducted for defining the table in FIG. 7;

FIG. 9 is a graph showing the difference in temperature of the print head depending on the number of scans of a carriage in the inkjet printing apparatus shown in FIG. 2A;

FIG. 10 is a flowchart showing the steps in the process for maintenance of the inkjet printing apparatus according to the first embodiment of the present invention;

FIG. 11A is a plan view illustrating the print head in an inkjet printing apparatus according to a second embodiment, and FIG. 11B is a diagram illustrating the ejection ports assigned to each area;

FIG. 12A is a plan view illustrating part of the ejection ports of the print head used in an inkjet printing apparatus of a third embodiment, and FIG. 12B is a table showing the relationship between the shape of the ejection ports and the ejection port-shape coefficient used when the amount of collected sub-droplets is calculated;

FIG. 13 is a flowchart showing the steps in the process for maintenance of the inkjet printing apparatus according to the third embodiment of the present invention;

FIG. 14 is a diagram illustrating the order of the blocks for driving in each printing mode used in an inkjet printing apparatus according to a fourth embodiment of the present invention;

FIG. 15 is a table showing the relationship between the order of blocks for driving and the coefficient of the order of the blocks for driving, used for calculating the amount of sub-droplets collected; and

FIG. 16 is a flowchart showing the steps in the process for maintenance of the inkjet printing apparatus according to the fourth embodiment of the present invention.

### DESCRIPTION OF THE EMBODIMENTS

### First Embodiment

A first embodiment for carrying out the present invention will be described below with reference to the accompanying drawings.

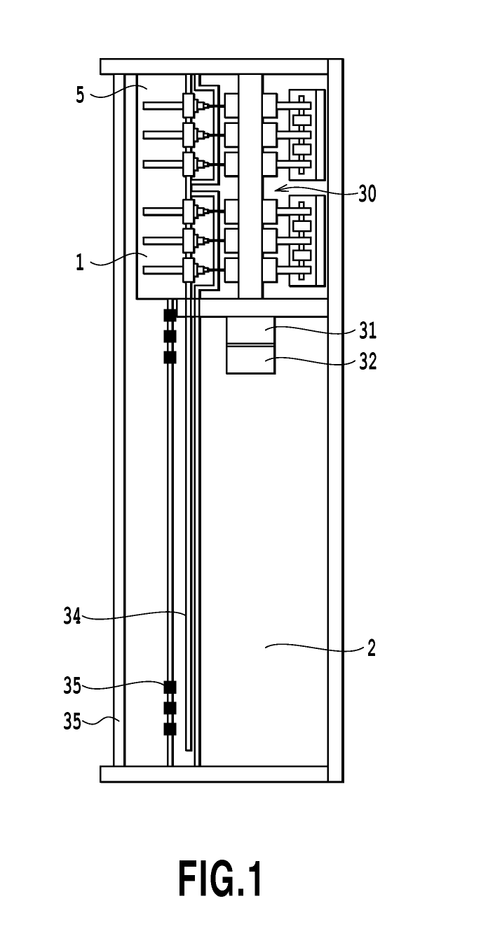

FIG. 1 shows a plane view of an inkjet printing apparatus according to the first embodiment. The inkjet printing apparatus in the first embodiment prints on a relatively large-sized sheet of paper (printing medium). As shown in FIG. 1, the inkjet printing apparatus body has a sheet-feeding system unit 2.

The sheet-feeding system unit 2 has a carriage 1 in which six inkjet cartridges are mounted in correspondence with a plurality of colors which will be described later. Each of the inkjet cartridges 101 has a print head 5. The print head 5 has an array of a plurality of ejection ports for ejecting ink. The sheet-feeding system unit 2 has a guide shaft 33 for guiding the carriage 1. The carriage 1 is supported and guided movably along the guide shaft 33. The carriage 1 can be reciprocated along the guide shaft 33 by a driving force transferred through a belt 34. In this manner, the sheet-feeding system unit 2 in the inkjet printing apparatus is structured to allow the print heads 5 to scan the printing medium.

The colors of ink used in this embodiment are six in total, cyan, magenta, yellow and black, and additionally, light cyan and light magenta for the purpose of reducing the grain visibility. The inkjet printing apparatus 100 has a recovery mechanism 30, and caps respectively corresponding to the print heads 5. The caps are provided in positions respectively corresponding to the ejection ports 102 for protecting each print head 5 when the print head is not used. When the ejection ports 102 is blocked off by the cap, the recovery mechanism 30 is capable of sucking operation using a pump, not shown, as the power source. The recovery mechanism 30 has a pre-ejected ink receiving container 31 that temporarily receives the ink ejected from each of the print heads 5 in the pre-ejection operation. The ink received by the pre-ejected ink receiving container 31 will be discharged afterward. The recovery mechanism 30 further has a wiping mechanism 32 for performing a wiping operation on the ejection port faces of the respective print heads 5.

The inkjet printing apparatus is further equipped with encoder films 35 arranged along the path of movement of the carriage 1 for detecting the position after movement of the carriage 1. For the detection of the position of the carriage 1 in the inkjet printing apparatus, an encoder sensor mounted on the carriage 1 detects the encoder film 35. Thereupon, based on the signal from the encoder sensor, the inkjet printing apparatus can detect the position of the carriage 1. In addition the inkjet printing apparatus can control the movement of the carriage 1 to its home position on the basis of the positional detection of the encoder.

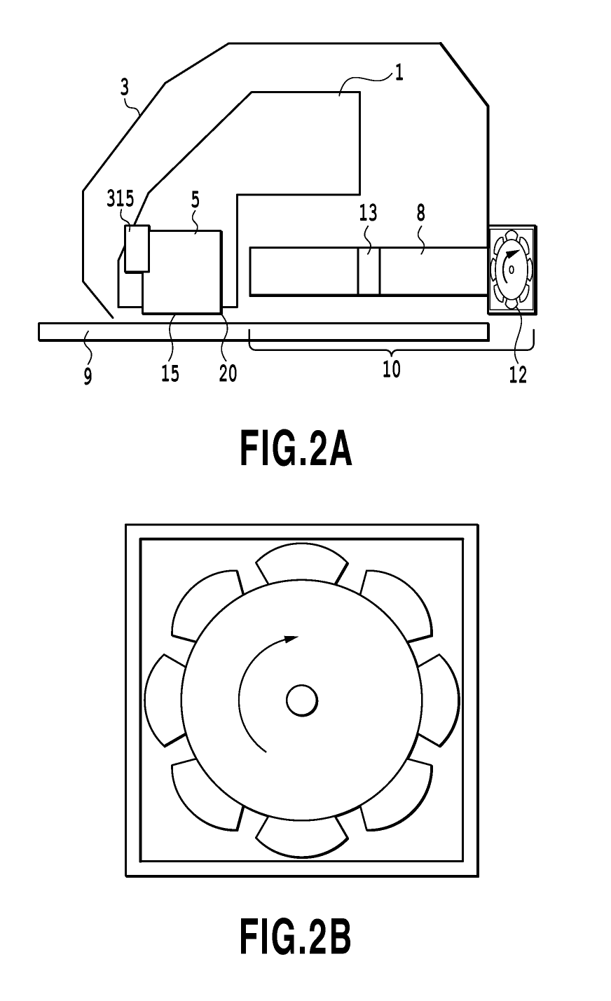

FIG. 2A shows a sectional view of the inkjet printing apparatus body of this embodiment.

A housing 3 which forms the exterior of the inkjet printing apparatus body is provided with a wind-powered collecting mechanism (collecting mechanism) 10 for sucking the air from the space between the printing medium, the platen 9 and the print head 5, and collecting sub-droplets, such as satellites or ink mist, formed in the space. The wind-powered collecting mechanism 10 comprises a collecting fan 12, a duct 8 and a filter 13. The collecting fan 12 sucks the air from the inside of the inkjet printing apparatus and sends it to the outside. The filter 13 collects the ink mist or satellites floating in the air in the space between the print head 5 and the printing medium and temporarily holds the collected ink mist or satellites. The duct 8 guides the sucked air from the inside of the inkjet printing apparatus toward the filter 13 or the collecting fan 12. The ejection ports of each of the print heads 5 are formed in a face 15, and a head edge 20 is the part of the print head 5 located closest to the wind-powered collecting mechanism 10.

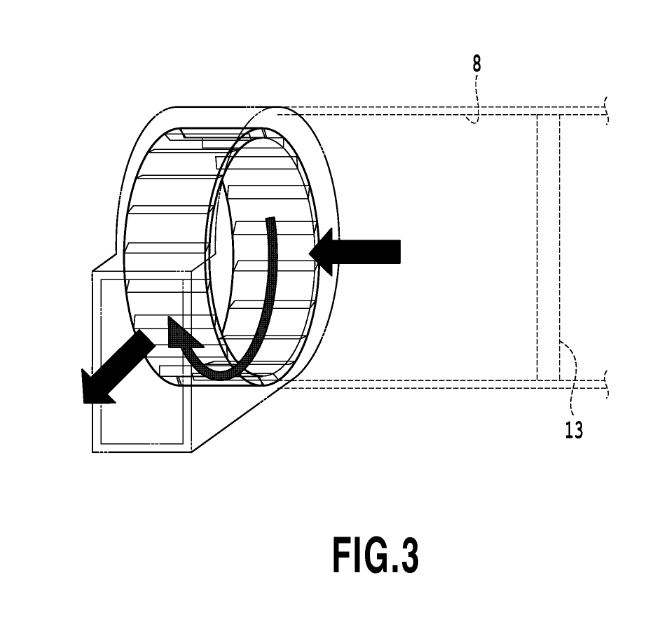

FIG. 2B shows an enlarged view of the collecting fan 12 used in the wind-powered collecting mechanism 10. The collecting fan 12 illustrated in FIG. 2B is an axial fan. The rotational driving of the collecting fan 12 produces an air current flowing from the space between the print head 5 and the printing medium through the duct 8 toward the filter 13. At this point, a preferable velocity of the sucked wind ranges from 0.001 m/sec to 5 m/sec in the head edge 20. The collecting fan 12 used here is not limited to the axial fan illustrated in FIG. 2B, and a sirocco fan as illustrated in FIG. 3 may be employed. In particular, for the moving of the ink mist or satellites under the conditions of setting a low speed for the rotation of the collecting fan 12, the use of the sirocco fan is suitable because it can stably supply a flow of air at a required wind velocity. Any other type of fan or other structure of duct may be employed as long as they can suck the satellites or ink mist from the space between the print head 5 and the printing medium.

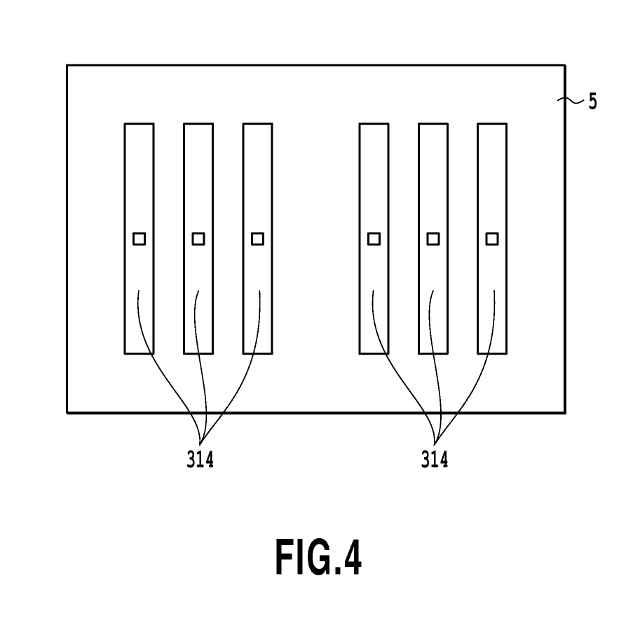

FIG. 4 is a plan view of the ejection port face of the print heads 5 in which the ejection ports are formed as used in this embodiment. In each of the ejection port rows corresponding to the colors, the 1280 ejection ports are arrayed at a density of 1200 dpi (dot/inch) in the sub-scan direction at right angles to the scan direction as shown in FIG. 4. The ejection ports are respectively interconnected to ink passages in which electrothermal transducers, not shown, are disposed in positions respectively corresponding to the ejection ports. Upon the passage of electric current, the electrothermal transducers are driven to locally heat the ink to cause film boiling. The pressure thus developed ejects the ink. A plurality of ejection port rows each having an array of the 1280 ejection ports are arranged in the print head 5 for each of the plurality of ink colors. As shown in FIG. 4, a head temperature sensor (temperature detecting means) 314 is disposed in approximately the central portion of each of the ejection port rows in order to detect the temperature of the position corresponding to each ejection port row of the print head 5.

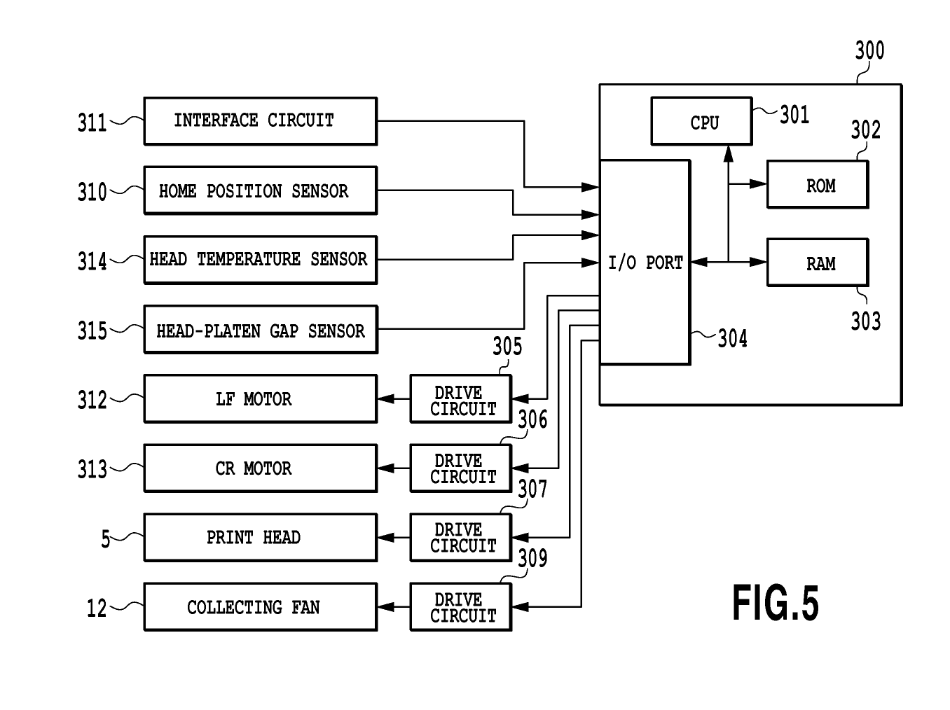

FIG. 5 shows a block diagram illustrating the configuration of a control system circuit in this embodiment. In this embodiment, the main control unit 300 in the inkjet printing apparatus is connected to a host computer, not shown, through an interface circuit 311. The main control unit 300 has a CPU 301, a ROM 302, a RAM 303 and I/O port 304, and controls various operating components of the inkjet printing apparatus. The CPU 301 executes processing operations such as calculation, control, determination, setting and the like. The ROM 302 stores control programs and the like which are executed by the CPU 301. The RAM 303 is used as a buffer for printing data, a work area for the processing of the CPU 301, or the like.

The I/O port 304 is connected to a feeding motor (LF motor) 312, a carriage motor (CR motor) 313, the print heads 5, a collecting fan 12 and the like through the respective drive circuits 305, 306, 307 and 309. The I/O port 304 is connected to sensors such as a head-platen gap sensor 315, head temperature sensors 314 and a home-position sensor 310, and the interface circuit 311. The head-platen gap sensor 315 detects the distance between the face 15 of the print head 5 (in which the ejection ports of the print head are formed) and the printing medium or the platen. The head temperature sensors 314 detect the temperature at the print heads 5. The home position sensor 310 is operated when the carriage 1 is moved to its home position in which the recovery operation is performed. The interface circuit 311 is provided for receiving and transmitting information. For example, the main control unit 300 obtains the temperature information detected by the head temperature sensors 314 from the I/O port 304 through the interface circuit 311.

Next, the printing operation of the inkjet printing apparatus of this embodiment will be described.

Upon the reception of the printing data from the host, the inkjet printing apparatus structured as described above moves the carriage 1 along the guide shaft 33 through the whole width direction (the main scan direction) for the printing. In this movement, the inkjet printing apparatus is controlled such that the ink droplets are ejected while the printing medium sent by the sheet-feeding unit 2 is moved, in order to provide a desired image through the printing operation. Thus, each of the print heads 5 is scanned so as to print part of an image of characters, pictures or the like corresponding to one band (a printable area in a print scan of the print heads) on the printing medium. The printing medium is sent by the sheet-feeding unit for a predetermined distance (one band or a distance corresponding to the printed width printed by a predetermined number of printing elements) in a direction (the sub scan direction) crossing the main scan direction of the carriage 1. A serial scan type of inkjet printing apparatus repeats the scan operation and the feeding operation for printing in this manner. The printing apparatus of the present invention is not limited to a serial scan type in which the print heads are scanned in the width direction of the printing medium, and is applicable to a full-line type of printing apparatus in which the print heads cover the printing medium over the width direction and are not scanned in the width direction.

In this embodiment, when the inkjet printing apparatus operates the print heads 5 to eject the ink droplets to the printing medium for the printing, in addition to the main droplet ejected as the ink droplet, a sub droplet, such as a satellite or ink mist, is produced. The sub droplet here described means a portion of the ejected ink droplet having a smaller liquid volume than that of the main droplet and ejected to a position different from the predetermined impacting position of the main droplet.

When the inkjet printing apparatus starts printing, the wind-powered collecting mechanism 10 is actuated so that the collecting fan 12 in the wind-powered collecting mechanism 10 is driven so as to start rotating. Then, the satellites or ink mist produced in the space between the print heads 5 and the printing medium are collected into the wind-powered collecting mechanism 10. During the printing operation of the inkjet printing apparatus, the collecting fan 12 continues to rotate so that the satellites or ink mist produced in printing are immediately collected by the wind-powered collecting mechanism 10. By the suction of the collecting fan 12, the satellites or ink mist collected into the wind-powered collecting mechanism 10 adhere to the filter 13 or the wall face of the duct 8 so as to be held inside the wind-powered collecting mechanism 10. In this manner, the satellites or ink mist produced in printing are collected in order to be prevented from adhering to the printing medium, thus leading to a reduction in the quality of the image obtained by the printing operation. In addition, the satellites or the ink mist produced in printing are prevented from adhering to the inside of the inkjet printing apparatus, thus making the inside of the inkjet printing apparatus dirty. As a result, a reduction in the durability of the inkjet printing apparatus itself is prevented.

However, the amount of satellites or ink mist collected by the wind-powered collecting mechanism 10 is limited. If the same wind-powered collecting mechanism 10 is continuously used for collection, the amount of satellites or ink mist collected will exceed the capacity of the filter 13 or the duct 8 for holding the satellites or ink mist. If the satellites or ink mist continue to be collected even after the holding capacity of the filter 13 or the duct 8 is exceeded, the filter 13 becomes clogged and the efficiency of collecting the satellites or ink mist is reduced. In addition, the misty satellites or ink mist adhering to the inner wall of the duct 8 may possibly join up together to form a droplet having a certain size, which will then leak from the duct. Accordingly, to avoid this circumstance, the wind-powered collecting mechanism 10 is required to be replaced when it has outlived its life. That is, when the limit of the capacity of the filter 13 or the duct 8 for holding the satellites or ink mist is reached, the need for replacement of the wind-powered collecting mechanism 10 arises.

For this reason, when the amount of satellites or ink mist held by the wind-powered collecting mechanism 10 exceeds a certain value, the wind-powered collecting mechanism 10 is replaced with a new one which has no satellites or ink mist adhering thereto. In this embodiment, it is the filter 13, the duct 8 and the collecting filter 12 that are replaced by new ones. After the replacement, the new wind-powered collecting mechanism 10 is used to collect satellites or ink mist subsequently formed. Then, when the limit of the collecting amount of the wind-powered collecting mechanism 10 is again reached, the filter 13, the duct 8 and the collecting fan 12 are once more replaced.

In this connection, in order to detect the suitable time for replacing the filter 13, the duct 8 and the collecting fan 12, it is necessary to know the amount of satellites or ink mist that has been collected by then. In this embodiment, whenever printing is performed, the amount of satellites or ink mist generated is calculated, and the calculated amounts generated are continuously added together to calculate the amount of satellites or ink mist that have been collected up to that time. Then, the amount of satellites or ink mist generated in each printing is added to the amount of satellites or ink mist generated up to then, in order to calculate the total amount of satellites or ink mist generated up to the time of printing.

Next, factors affecting the amount of satellites or ink mist collected in printing will be described. The factors affecting the amount of satellites or ink mist collected include the amount of ink ejected to the printing medium, the amount of evaporation of the ejected ink, the distance between the print heads 5 and the printing face of the platen 9, the collection efficiency of the collecting fan 12, and the temperature of the print head in ejection.

Regarding the amount of ink ejected to the printing medium, the larger the amount of ink ejected, the larger the amount of satellites or ink mist occurring. This is because, as the amount of ink ejected is larger, the amount of ink splashing after having struck the printing medium increases, thereby increasing the amount of satellites or ink mist generated. The higher the ejection duty indicating the amount of ink drops impacting per unit area, the larger the amount of satellites or ink mist generated. The number of ejections is a value which can be counted during the printing. The amount of ink ejected per one ejection is a value previously obtained for each ejection port.

The amount of ink evaporating varies from ink color to ink color. That is, the amount of evaporation is unique to each type of ink. As the amount of ink evaporating increases, the amount of ink floating in the air is increased. Then, the floating ink is cooled while floating in the space between the print heads 5 and the printing medium, resulting in occurrence of satellites or ink mist.

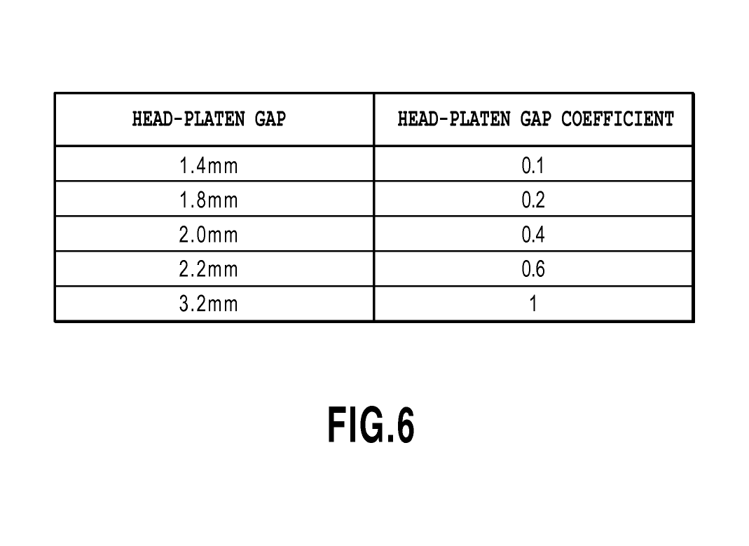

Regarding the distance between the print head 5 and the printing face of the platen 9, the longer the distance, the larger the amount of satellites or ink mist generated. This is because, if the distance between the print head and the printing medium is increased, a satellite adheres to a position of the printing medium distant from the position of the main droplet, or alternatively, ink mist is floating in the air for a longer time period while being affected by the current of air produced when the ink is ejected. FIG. 6 shows a table of the relationship between the distance from the ejection port face of the print head 5 to the platen and a head-platen gap coefficient which will be described later. The longer the distance from the ejection port face to the platen, the higher the head-platen gap coefficient. In this manner, it is understood that as the distance from the ejection port face to the platen is longer, the amount of satellites or ink mist generated increases. The head-platen gap coefficient is determined by use of the table in FIG. 6 on the basis of the length measured by the head-platen gap sensor 315.

The efficiency of collection by the collection mechanism depends on factors such as the blade shape of the collecting fan 12, the rotational speed set when the collecting fan 12 is driven, and the duct shape.

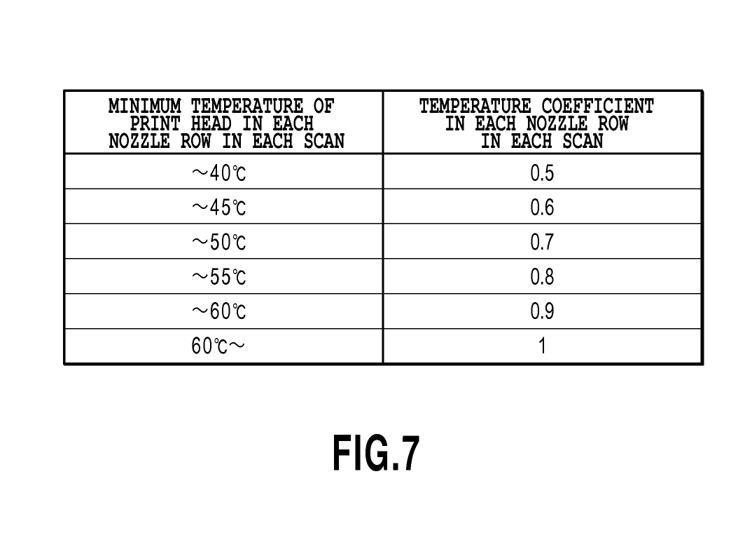

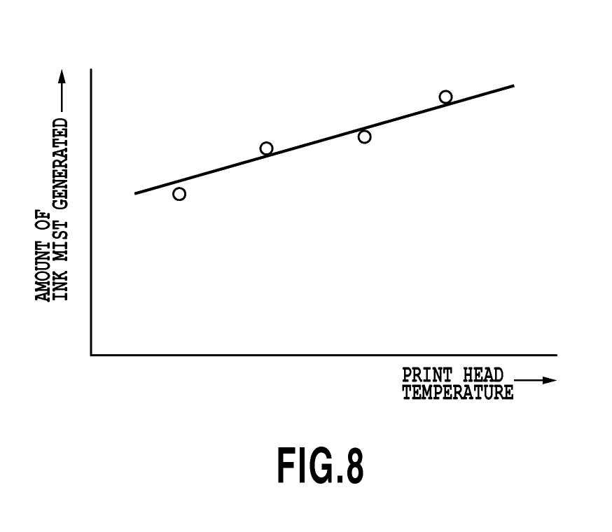

Regarding the temperature of the print head in the ejection operation, the higher the temperature, the higher the amount of satellites or ink mist occurring. The reason for this is that the temperature of the ink increases along with an increase in temperature of the print head. Because of this, the viscosity of the ink decreases, so that sub-droplets easily separate from the main droplet. Accordingly, it is thought that the amount of satellites or ink mist is increased by easy separation of the droplets. “The temperature coefficient in each scan in the ejection port row”, which will be described later, is determined by use of the table in FIG. 7 on the basis of the temperature actually measured by the head temperature sensor 314 mounted on the print head 5. The values shown in the table in FIG. 7 are derived on the basis of the experiment results shown in FIG. 8. In this embodiment, the information about the head temperature is detected directly by the head temperature sensors 314. Then, the amount of ink mist collected is measured on the basis of the detected information about the head temperature. In this embodiment, the minimum temperature is detected in each scan as information on temperature of the print heads 5, and a coefficient is determined based on the detected minimum temperature.

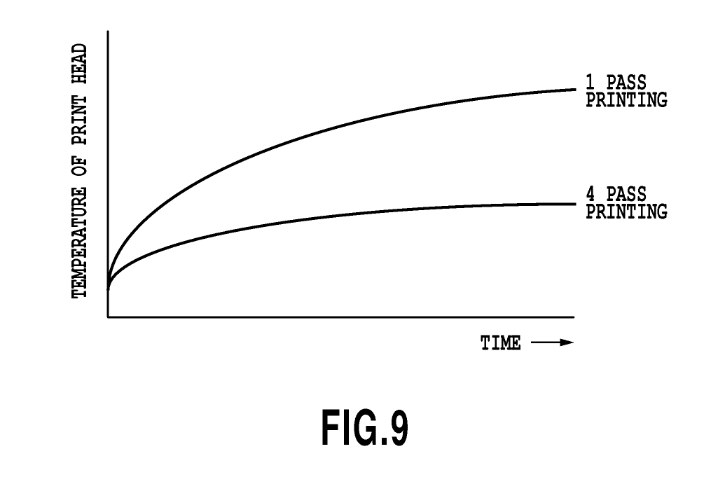

Regarding the temperature of the print head 5, the temperature increases basically along with an increase in the number of ejections per unit time. Accordingly, the higher the printing duty, the higher the temperature of the print head 5. When multipass printing is performed at the same printing duty, the lower the number of scans required for completing the image in a certain area, the higher the temperature of the print head. FIG. 9 shows the relationship between the passage of time and the temperature of the print head in the above case.

From the above relationship, the amount of satellites or ink mist generated in each back-and-forth scan (a scan) in printing is calculated by use the following equation. For this calculation, in the equation, the amount of ink ejected from each ejection port row in each scan is multiplied by the following coefficients. Specifically, the coefficients are the minimum temperature measured at each ejection port row, the evaporation coefficient of from ink type to ink type, the coefficient based on the head-platen gap detected by the head-platen gap sensor 315, the temperature coefficient of the ejection port row, and the efficiency of collection by the collecting mechanism.

(The amount of ink mist collected in each ejection port row in each scan)=(the number of ejections from each ejection port row in each scan)×(the amount of ink ejected from each ejection port)×(the evaporation coefficient of the ink mist)×(the head-platen gap coefficient)×(the temperature coefficient of each ejection port row in each scan)×(the efficiency of collection by the collecting mechanism).

About the calculated amount of satellites or ink mist generated in each scan, the all amounts calculated throughout the printing process are added together to calculate the total amount of satellites or ink mist generated in this printing. Then, the previous total amount of satellites or ink mist generated up to the last printing is read from the RAM 302. Then, the previous total amount of satellites or ink mist generated up to the last printing and the total amount in this printing are added together to calculate the amount of satellite or ink mist collected and held by the wind-powered collecting mechanism 10 at this time.

In this manner, the inkjet printing apparatus 100 of this embodiment has head temperature sensors 314 for obtaining the temperature information on the print heads 5, and calculates the amount of sub droplets generated, such as satellites or ink mist, on the basis of the printing conditions including the temperature information of the print heads 5. Note that the CPU 301 operates as a sub-droplet amount calculating mean to calculate the amount of sub-droplets generated.

Then, the inkjet printing apparatus 100 operates the CPU 301 to determine whether or not the replacement of the wind-powered collecting mechanism 10 is necessary on the basis of the generated amount of satellites or ink mist which has been calculated by the CPU 301 serving as the sub-droplet amount calculating mean. Specifically, a threshold is preset for the collection amount of satellites or ink mist collected. When the calculated collection amount exceeds the threshold, the filter 13, the duct 8 and the collecting fan 12 of the wind-powered collecting mechanism 10 are replaced. In this manner, the CPU 301 has the function as a replacement necessity determining mean for deciding necessity/unnecessity of replacement of the wind-powered collecting mechanism 10 on the basis of the calculated amount of satellites or ink mist generated.

The threshold is set in this embodiment as the limit of the volume of the satellites or ink mist collected in the wind-powered collecting mechanism 10. That is, when an extremely large amount of satellites or ink mist adheres to the filter 13, the filter is clogged with the collected satellites or ink mist, and then the efficiency of collecting them starts to reduce. The amount of satellites or ink mist collected at this point is set as a threshold. In addition, the threshold is desirably set to a value which can prevent a droplet formed of an aggregate of misty ink mist adhering to the wall face of the duct 8 from leaking from the wind-powered collecting mechanism 10.

Regarding the temperature information of the print heads 5, a plurality of head temperature sensors 314 are arranged on portions of print head 5 so as to correspond to groups of ejection ports formed within a plurality of regions into which the face of the print head 5 is sectioned. The temperature information of each of the groups of ejection ports is obtained from the head temperature sensor 314 which is assigned to the group of ejection ports. In particular, in the embodiment, a plurality of head temperatures sensor 314 are arranged on each print head 5 and respectively assigned to the ejection port rows, so that the temperature information of each of the ejection port rows is obtained from the head temperature sensor 314 assigned to the ejection port row. The CPU 301 serving as the sub-droplet amount calculating mean calculates the amount of satellites or ink mist generated on the basis of the printing conditions including the temperature information of each ejection port row.

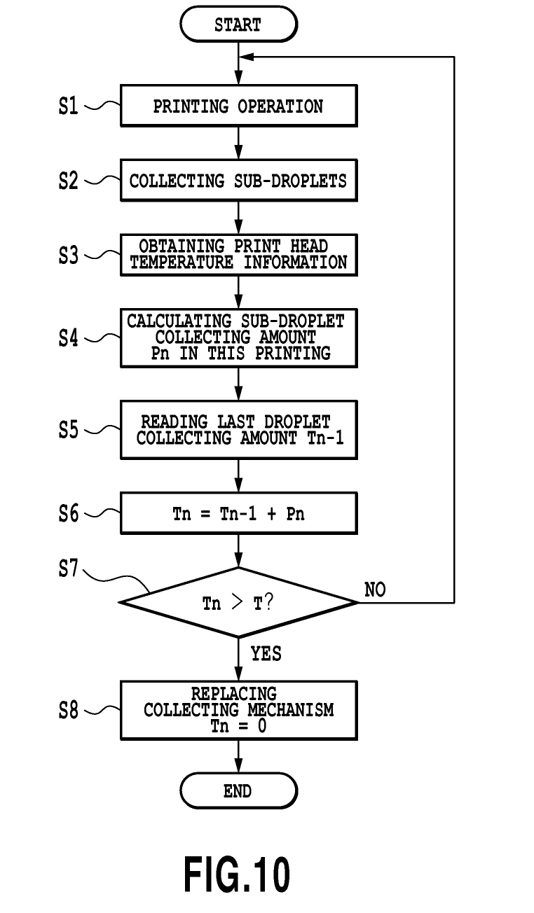

FIG. 10 shows a flowchart of the processes in the maintenance method for the inkjet printing apparatus in this embodiment.

First, upon the start of printing operation (s1), the wind-powered collecting mechanism 10 collects sub-droplets resulting from this printing (s2) (collecting process). Temperature information of the print heads 5 in printing is obtained (s3) (temperature obtaining process). Based on various printing conditions including the obtained temperature information, the amount of satellites or ink mist generated formed in each scan is calculated (sub-droplet amount calculating process). Then, the amounts generated in all scans in this printing are added together to calculate the amount Pn of satellites or ink mist resulting from this printing and collected by the wind-powered collecting mechanism 10 (s4). An amount Tn−1 of satellites or ink mist collected up to the previous printing is read from the RAM 302 (s5). The amount Pn of sub-droplets collected in this printing and the amount Tn−1 of sub-droplets collected up to the previous printing are added together to calculate a total collection amount Tn of sub-droplets as a result of the collection after the printing has been terminated. Then, the collection amount Tn of satellites or ink mist collected and held by the wind-powered collecting mechanism 10 at this time is compared with a threshold T relating to a preset collection amount (s7). Then, if the collection amount Tn at this time exceeds the threshold T, the inkjet printing apparatus determines that the collection amount Tn exceeds the capacity of the collecting mechanism 10 for holding the collected sub-droplets, and decides to replace the filter 13, the duct 8 and the collecting fan 12 in the wind-powered collecting mechanism 10 (s8) (replacement necessity/unnecessity determining process). In this case, the inkjet printing apparatus may use the display to prompt the user to replace these components. If the collection amount Tn does not exceed the threshold T, the components of the wind-powered collecting mechanism 10 are not replaced and continuously used as they are, so that the in-use wind-powered collecting mechanism will be used in the next printing.

In this manner, since the amount of satellites or ink mist collected is properly calculated with taking a change in temperature of the print head 5 into account, the components are replaced in suitable time. For this reason, it is possible to inhibit leakage of the droplets formed by joining the satellites or the ink mist together from the wind-power collecting mechanism 10 and adhesion of the leaked droplets to the user or the printing medium as happen in the case of a delay in replacing the wind-powered collecting mechanism 10. It is also possible to inhibit the endurance of the inkjet printing apparatus 100 from being reduced by the leaking droplets. In addition, it is possible to inhibit the maintenance costs of the inkjet printing apparatus from increasing by replacing the components extremely earlier than proper time.

In the printing mode of a serial scan type printing apparatus, there are a one-pass printing mode in which printing is performed in one pass on the same printing area, and a multi-pass printing mode in which an image is generated in a plurality of printing passes. Both printing modes, the one-pass printing mode and the multi-pass printing mode, are compared with each other. Even when images are printed at the same printing duty, the amount of satellites or ink mist generated is higher in the one-pass printing mode. In the same multi-pass printing modes, the amount of satellites or ink mist generated is higher when the number of scans is lower. However, according to this embodiment, the amount of ink ejected or the temperature of the print head have been already taken into account for the aforementioned coefficients, and the amount of satellites or ink mist generated is calculated. As a result, the amount of satellites or ink mist generated is precisely calculated. In this manner, the collection amount of sub-droplets can be calculated, with consideration given to the differences in circumstances between when the number of scans is low for printing an image in a certain area, that is, the conditions of a high temperature of the print head and a large amount of satellites or ink mist generated, and when the number of scans is high for printing an image in a certain area, that is, the conditions of a low amount of satellites or ink mist generated. Thus, it is possible to more accuracy calculate the amount of satellites or ink mist generated by addressing the complicated printing conditions.

In this embodiment, the CPU 301 in the inkjet printing apparatus 100 calculates the amount of sub-droplets generated, but this is not limited. The amount generated may be calculated in another part, for example, in a computer of the host system. A part for storing the amount of satellites or ink mist generated up to the last printing is not limited to the RAM 302 in the inkjet printing apparatus 100, and may be another part of the host system, or the like. Furthermore, the CPU 301 determines, based on the calculated amount of satellites or ink mist generated, whether or not the replacement of the wind-powered collecting mechanism 10 is necessary, but another part or the like, for example, the host system may be determines.

In this embodiment, for determining the “temperature coefficient in each scan in the ejection port row”, the minimum temperature is detected in each scan, and then a coefficient is determined based on the minimum temperature. However, the present invention is not limited to this embodiment. An average temperature in one scan may be used. Alternatively, a maximum temperature achieved in a scan may be employed for the purpose of prompting the user to replace the components with safety in mind.

In this embodiment, when the CPU 301 serving as the replacement necessity determining mean determines that the replacement is necessary, the filter 13, the duct 8 and the collecting fan 12 are replaced. However, the present invention is not limited to this embodiment. Instead of all these components, part of them may be replaced. For example, when the CPU 301 determines that the replacement is necessary, the filter 13 alone may be replaced. In this case, a threshold for determining whether or not the replacement is necessary may be defined in accordance with the capacity which the filter 13 hold the satellites or ink mist generated.

### Second Embodiment

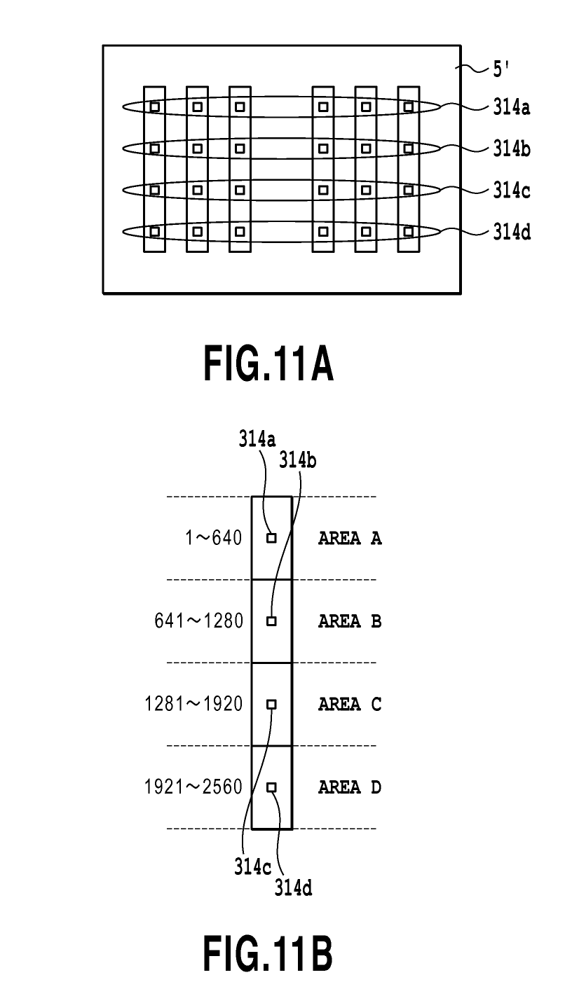

Next, a second embodiment will be described with reference to FIG. 11. The same components as those in the first embodiment are designated with the same reference number in FIG. 11 as those in the first embodiment, and a description is omitted. The structure differing from the first embodiment will be described.

In the print head in the first embodiment, a single head temperature sensor 314 is arranged in approximately the central portion of each of the ejection port rows, and the amount of satellites or ink mist generated is calculated on the basis of the temperature at each ejection port row. By contrast, in the second embodiment, a plurality of head temperature sensors 314 are arranged in each of the ejection port rows. The amount of ink mist is calculated in accordance with the head temperature distribution based on a plurality of head temperature sensors 314. The second embodiment is particularly effective for an inkjet printing apparatus using long print heads. In some inkjet printing apparatus, the length of the print head is increased because the number of ejection ports is increased for the purpose of achieving faster printing and higher definition. Thus, printing is performed with high density dots, resulting in a high quality image. However, because the length of the print head is increased, the length of the ejection port row is increased, resulting in a relatively enormous difference in the temperature distribution of each ejection port row. Heat is dissipated from the ejection ports located close to the two ends of each ejection port row, to the outside of the print head, so that the temperature in these ejection ports is not relatively increased. On the other hand, heat is not much dissipated from the ejection ports located close to the central portion, so that the temperature in the central portion is relatively high.

In a print head 5′ of the second embodiment, the 2560 ejection ports 102 are arrayed in each row at a density of 1200 dpi (dot/inch) in the sub-scan direction at right angles to the scan direction. As shown in FIG. 11A, the four head temperature sensors 314a, 314b, 314c and 314d are arranged in each ejection port row. FIG. 11B shows the 2560 ejection ports which are numbered beginning at one end of the row and divided into groups based on areas.

This embodiment takes into account the temperature difference caused in the same ejection port row which is apt to be expanded in a long print head, and calculates the amount of sub-droplets generated such as satellites or ink mist. In this embodiment, each ejection port row is divided into four areas A, B, C and D. The first ejection port to the 640^{th} ejection port are assigned to the area A, the 641^{st} ejection port to the 1280^{th} the area B, the 1281^{st} ejection port to the 1920^{th} ejection port the area C, and the 1921^{st} ejection port to the 2560^{th} ejection port the area D. In this manner, the ejection port row is divided and the head temperatures corresponding to the respective areas are used. That is, the temperature information of the head temperature sensor 314a is used as a representative temperature in the area A. The temperature information of the head temperature sensor 314b is used as a representative temperature in the area B. The temperature information of the head temperature sensor 314c is used as a representative temperature in the area C. The temperature information of the head temperature sensor 314d is used as a representative temperature in the area D. Based on the representative temperature in each area, the amount of sub-droplets generated in the space between the area of the print head and the printing medium is calculated.

In this manner, in the same ejection port row, the ejection ports are divided into a plurality of areas so as to form groups of ejection ports in the respective areas. A plurality of the head temperature sensors 314 are arranged on the print head 5′ in such a manner as to be respectively assigned to the groups of ejection ports. The temperature obtaining means corresponding to the respective groups of ejection ports obtain the temperature information of the groups of ejection ports. The CPU 301 serving as the sub-droplet amount calculating mean calculates the amount of sub-droplets generated on the basis of the printing conditions including the temperature information of the groups of ejection ports.

Accordingly, the amount of ink mist collected in each ejection port row in each scan is calculated by the following equation.

(The amount of ink mist collected in each ejection port row in each scan)={(the number of ejections from the area A in each ejection port row in each scan)×(the temperature coefficient in the scan area A in each ejection port row)+(the number of ejections from the area B in each ejection port row in each scan)×(the temperature coefficient in the scan area B in each ejection port row)+(the number of ejections from the area C in each ejection port row in each scan)×(the temperature coefficient in the scan area C in each ejection port row)+(the number of ejections from the area D in each ejection port row in each scan)×(the temperature coefficient in the scan area D in each ejection port row)}×(the amount of ink ejected from each ejection port)×(the evaporation coefficient of the ink mist)×(the head-platen gap coefficient)×(the efficiency of collection by the collecting mechanism).

According to the second embodiment, because the amount of satellites or ink mist generated can be calculated with taking into account the difference of the temperature distribution existing in each ejection port row, the amount of ink collected in the wind-powered collecting mechanism 10 is more precisely calculated, thus more suitably determining time of replacement.

### Third Embodiment

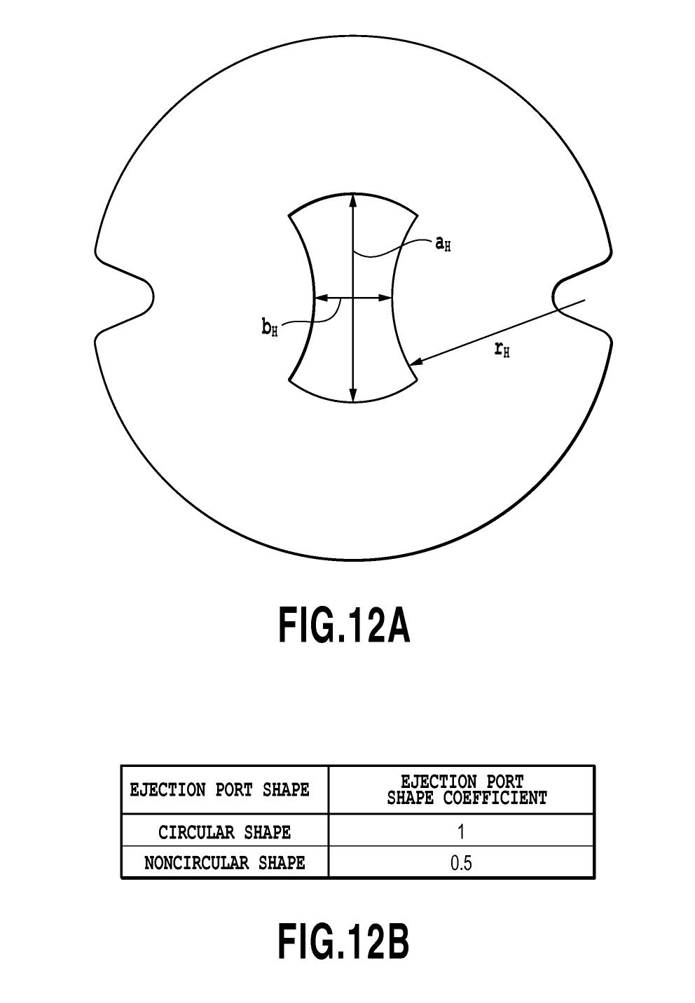

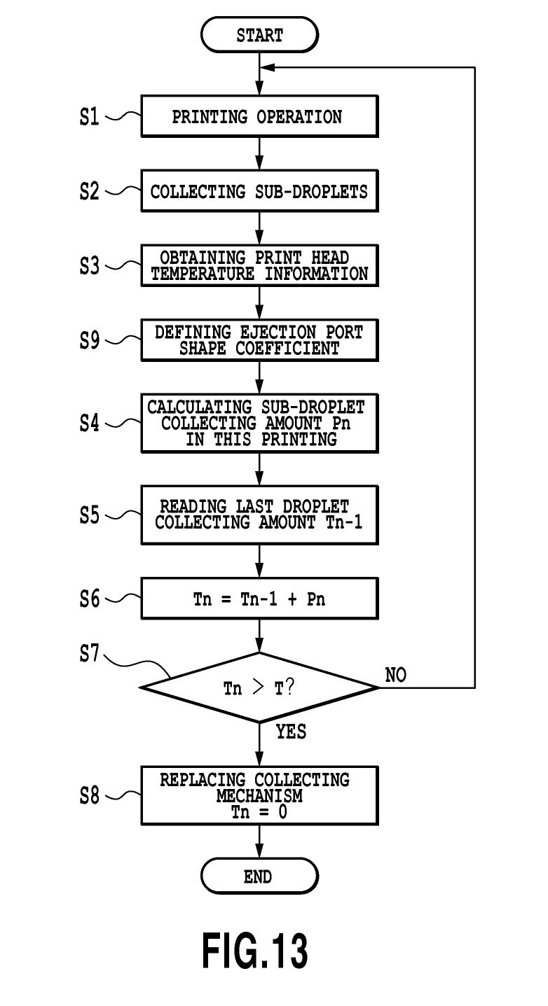

Next, a third embodiment will be described with reference to FIG. 12A, FIG. 12B and FIG. 13. The same components as those in the first embodiment and the second embodiment are designated with the same reference number in FIGS. 12A, 12B and 13 as those in the first and second embodiments, and a description is omitted. The structure differing from the first and second embodiment will be described.

In the first embodiment and the second embodiment, the collection amount of satellites or ink mist collected is calculated on the basis of the printing conditions including the temperature information of the print head. The third embodiment takes into account a difference in the amount of sub-droplets generated because of the shape of the ejection port, and calculates the amount of sub-droplets.

Each of the print heads of the third embodiment has two types of ejection ports formed thereon. Typically circular shaped ejection ports and noncircular shaped ejection ports, as disclosed in Japanese Patent Laid-Open No. H10-235874 illustrated in FIG. 12A, are arranged selectively based on the types of ink. The noncircular shaped ejection port can reduce the ink mist, but, depending on the type of ink, cannot provide smooth ink ejection particularly after having lain unused for a short time. In particular, when the print head with the noncircular shaped ejection port is used in a printing apparatus with a large scan width, even after the sufficient pre-ejection, faint printing results. To avoid this, the embodiment employs the circular shaped ejection port for ink which cannot be smoothly ejected after a short unused period, and the noncircular shaped ejection ports for other types of ink.

Because the use of noncircular shaped ejection ports makes it possible to significantly reduce the amount of ink mist as disclosed in Japanese Patent Laid-Open no. H10-235874, the amount of ink mist collected is calculated for each ejection port row in each scan is calculated by the following equation.

(The amount of ink mist collected in each ejection port row in each scan)=(the number of ejections from each ejection port row in each scan)×(the amount of ink ejected from each ejection port)×(the evaporation coefficient of the ink mist)×(the head-platen gap coefficient)×(the temperature coefficient of each ejection port row in each scan)×(the collection efficiency of the collecting mechanism)×(the coefficient of ejection port shape).

The CPU 301 serving as the sub-droplet amount calculating mean calculates the amount of sub-droplets occurring on the basis of the printing conditions including the shape of the ejection ports in the print head. FIG. 12B shows the relationship between the ejection port shape and the ejection port shape coefficient used in the calculation for the sub-droplets. According to this embodiment, since the amount of ink mist generated can be precisely calculated in accordance with the difference in the amount of sub-droplets generated attributed to the shape of the ejection port, it is possible to replace the wind-powered collecting mechanism 10 at a more appropriate time.

FIG. 13 shows a flowchart of the processes in the maintenance method for the inkjet printing apparatus in this embodiment.

First, upon the start of printing operation (s1), the wind-powered collecting mechanism 10 collects sub-droplets resulting from this printing (s2) (sub-droplet collecting process). Temperature information of the print heads 5 in printing is obtained (s3). In addition, an ejection port shape coefficient is defined from the shape of the ejection port in this embodiment (s9). Based on various printing conditions including the obtained temperature information and ejection port shape coefficient, the amount of satellites or ink mist generated in each scan is calculated (sub-droplet amount calculating process). Then, the amounts generated in all scans in this printing are added together to calculate the amount Pn of satellites or ink mist resulting from this printing and collected by the wind-powered collecting mechanism 10 (s4). An amount Tn−1 of satellites or ink mist collected up to the previous printing is read from the RAM 302 (s5). The amount Pn of sub-droplets collected in this printing and the amount Tn−1 of sub-droplets collected up to the previous printing are added together to calculate a total collection amount Tn of sub-droplets as a result of the collection after the printing has been terminated. Then, the collection amount Tn of satellites or ink mist collected and held by the wind-powered collecting mechanism 10 at this time is compared with a threshold T relating to a preset collection amount (s7). Then, if the collection amount Tn at this time exceeds the threshold T, the inkjet printing apparatus determines that the collection amount Tn exceeds the capacity of the collecting mechanism 10 for holding the collected sub-droplets, and decides to replace the filter 13, the duct 8 and the collecting fan 12 in the wind-powered collecting mechanism 10 (replacement necessity/unnecessity determining process). When determining that the replacement of the components of the wind-powered collecting mechanism 10 is necessary in the replacement necessity/unnecessity determining process, the inkjet printing apparatus may use the display to prompt the user to replace these components. If the collection amount Tn does not exceed the threshold T, the components of the wind-powered collecting mechanism 10 are not replaced and continuously used as they are, so that the in-use wind-powered collecting mechanism will be used in the next printing.

### Fourth Embodiment

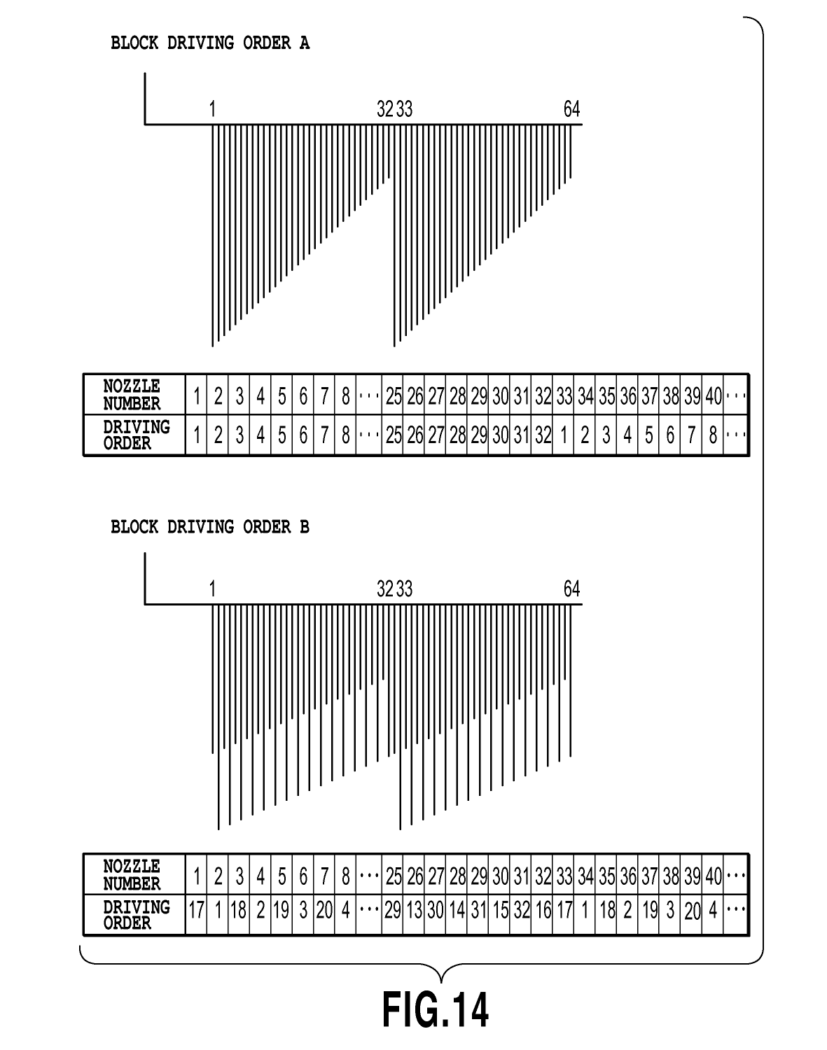

Next, a fourth embodiment will be described with reference to FIG. 14 to FIG. 16. The same components as those in the first embodiment to the third embodiment are designated with the same reference number in FIGS. 14 to 16 as those in the first to third embodiments, and a description is omitted. The structure differing from the first to third embodiments will be described.

The fourth embodiment takes into account a difference in the amount of sub-droplets generated in the order of blocks for driving when the print head is operated by use of block driving.

The method of driving the print heads of the fourth embodiment will be described below in detail. So-called block driving is known as an ejection drive method for the print head. In this driving method, ink is not simultaneously ejected from all the ejection ports of the print head. Instead, the ejection ports forming an ejection port row are divided into a plurality of blocks, and the ink is ejected from the ejection ports divided into the blocks on a block basis. Thus, the inkjet printing apparatus has the advantages, for example, of a reduction in electric power required for simultaneous ejection at one time.

However, depending upon the type of print head from which droplets are ejected, the order of the blocks for driving (hereinafter referred to as “block driving order”) may possibly have relatively large effects on image quality, the amount of mist generated and the like. For the purpose of minimizing such effects, this embodiment employs printing modes to select one of two types of block driving orders.

In this embodiment, the 1280 ejection ports are time-divided into 40 blocks each including the 32 ejection ports for driving.

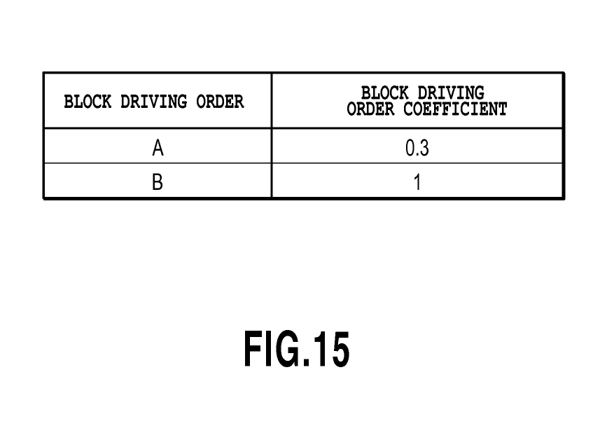

The block driving order A is used in a poster/photograph mode for printing mainly poster, photograph and the like. The block driving order B is used in a line-drawing mode for printing mainly a CAD drawing and the like. Each of the block driving orders are shown in FIG. 15.

The ejection ports are assigned numbers 1 to 1280. Considering the first to 32^{nd} ejection ports belonging to the block driving order A, the ink is ejected sequentially from the first to 32^{nd} ejection ports adjacent to each other. The ink is ejected from the 33^{rd} to 64^{th} ejection ports in a similar cycle, so that the ink is sequentially ejected from the adjacent ejection ports. In this case, a relatively long difference in time of ink ejection is caused between the 32^{nd} ejection port and the 33^{rd} ejection port. The ink droplets ejected from these ejection ports may possibly impact on different positions because of this difference in time of ink ejection. However, it is known that if the block driving order A is used for ink ejection, the amount of ink mist generated is smaller than that in the case of the block driving order B.

On the other hand, in the block driving order B, considering the first to 32^{nd} ejection ports, ink is ejected discretely from the first to 32^{nd} ejection ports. The ink is ejected from the 33^{rd} to 64^{th} ejection ports in a similar cycle to that in the case of the first to 32^{nd} ejection ports, so that the ink is ejected discretely by a relatively shorter time difference as a whole. The time difference between the 32^{nd} ejection port and the 33^{rd} ejection port is relatively short. The impacting positions of the droplets ejected from these ejection ports are relatively close to each other. However, it is known that the amount of ink mist generated is larger than that in the case of the block driving order A.

Possible causes of the difference in the amount of ink mist between the block driving orders A and B are described. In the block driving order A, the meniscus in the ejection port is affected by the ejection from the adjacent orifice, which makes unstable the meniscus state immediately before ejection. For this reason, the ejection speed of the ejected droplets is decreased, resulting in a lower amount of ink mist as compared with the block driving order B. In the block driving order B, ink is ejected from the adjacent ejection port at different time, relatively large difference, so that the ejection port is not affected by the ejection from the adjacent ejection port. As a result, the meniscus state immediately before the droplets is ejected is stable. For this reason, when the block driving order B is used to eject the ink, the ejection speed is increased. Accordingly, the amount of ink mist generated when the droplet rebounds from the printing medium after impacting is higher than that in the block driving order A.

From the characteristics as described above, in this embodiment, the block driving order A is selected for the poster/photograph mode because the misalignment of the impacting positions which is caused by a tiny difference in ejection time between the adjacent ejection port is not clear. The block driving order B is selected for the line drawing mode because the misalignment of the impacting positions which is caused by a tiny difference in ejection time between the blocks is not clear.

In this embodiment, the following equation is used to calculate the amount of sub-droplets with taking into account a difference in the amount of sub-droplets caused by the difference of the block orders.

(The amount of ink mist collected in each ejection port row in each scan)=(the number of ejections from each ejection port row in each scan)×(the amount of ink ejected from each ejection port)×(the evaporation coefficient of the ink mist)×(the head-platen gap coefficient)×(the temperature coefficient of each ejection port row in each scan)×(the efficiency of collection by the collecting mechanism)×(the block driving order coefficient).

In this manner, in this embodiment, the sub-droplet amount calculating mean calculates the amount of sub-droplets generated on the basis of the printing conditions including the order of ejecting ink droplets from the ejection ports in the ejection port row.

FIG. 15 shows the table of the relationship between the block driving order and the block driving order coefficient used in the calculation of the amount of sub-droplets collected. According to this embodiment, the amount of sub-droplets generated is calculated by considering the difference between the amounts of sub-droplets generated caused by the difference between the block driving orders. For this reason, the amount of sub-droplets generated is more precisely calculated, which making it possible to replace the wind-powered collecting mechanism 10 at more appropriate time.

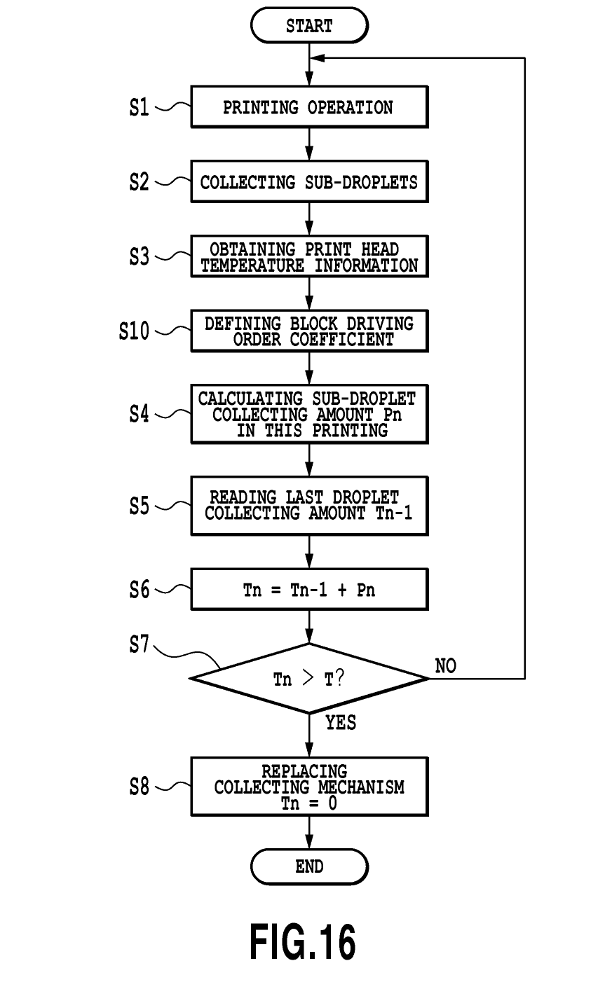

FIG. 16 is a flowchart showing the steps in the process for maintenance of the inkjet printing apparatus according to the fourth embodiment.

First, upon the start of printing operation (s1), the wind-powered collecting mechanism 10 collects sub-droplets resulting from this printing (s2) (sub-droplet collecting process). Temperature information of the printheads 5 in printing is obtained (s3). In addition to this, the block driving order coefficient is defined from the block driving order of the ejection ports in this embodiment (s10). Based on various printing conditions including the obtained temperature information and the block driving order, the amount of satellites or ink mist formed in each scan is calculated. Then, the amounts generated in all scans in this printing are added together to calculate the amount Pn of satellites or ink mist resulting from this printing and collected by the wind-powered collecting mechanism 10 (s4) (sub-droplet amount calculating process). An amount Tn−1 of satellites or ink mist collected up to the previous printing is read from the RAM 302 (s5). The amount Pn of sub-droplets collected in this printing and the amount Tn−1 of sub-droplets collected up to the previous printing are added together to calculate a total collection amount Tn of sub-droplets as a result of the collection after the printing has been terminated. Then, the collection amount Tn of satellites or ink mist collected and held by the wind-powered collecting mechanism 10 at this time is compared with a threshold T relating to a preset collection amount (s7). Then, if the collection amount Tn at this time exceeds the threshold T, the inkjet printing apparatus determines that the collection amount Tn exceeds the capacity of the collecting mechanism 10 for holding the collected sub-droplets, and decides to replace the filter 13, the duct 8 and the collecting fan 12 in the wind-powered collecting mechanism 10 (s8) (replacement necessity/unnecessity determining process). In this case, the inkjet printing apparatus 100 may use the display to prompt the user to replace these components. If the collection amount Tn does not exceed the threshold T, the components of the wind-powered collecting mechanism 10 are not replaced and continuously used as they are, so that the in-use wind-powered collecting mechanism will be used in the next printing.

The printing apparatus employed in the first to fourth embodiment corresponds to a plurality of colors. However, the present invention is applicable to a printing apparatus using an ink of a single color for printing. In addition, the present invention is applicable to a gradation printing apparatus which uses a single ink for printing and prints at different densities with the same color and a printing apparatus which is of a combined type of the gradation printing apparatus and one corresponding to a plurality colors. In these cases, the same advantageous effects can be provided.

Further, the plurality of the above embodiments may be combined, and may be determined whether a replacement of the collecting mechanism is necessary or not on the basis of the plurality of the values as described above embodiments combined. Determining whether the replacement of the collecting mechanism is necessary or not is done by such combined manner is involved in the embodiment of present invention. For example, the temperature of the print head, the gap between the print head and print medium, the block driving order that ink is ejected from block of ejection port by driving in case the plurality of the ejection ports are divided into blocks, or the like, may be taken into account simultaneously for calculating the amount of satellites or ink mists generated. These means for calculating the amount of satellites or ink mists generated are involved in present invention. That is, plurality of conditions are taken into account at the same time and a timing of the replacement of the collecting mechanism is determined by using the plurality of conditions, which makes it possible to indicate to user so that the collecting mechanism is replaced, at more appropriate time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-187396, filed Jul. 18, 2007, which is hereby incorporated by reference herein in its entirety.

What is claimed is:

1. An inkjet printing apparatus using print heads for ejecting liquid droplets to a printing medium for printing, comprising:
a sub-droplet collecting portion that collects sub-droplets each having a smaller liquid volume than that of a main droplet in each of the liquid droplet produced by the ejection;
a temperature obtaining mean that obtains temperature information of the print heads;
a sub-droplet amount calculating mean that calculates the amount of sub-droplets generated on the basis of printing conditions including the temperature information of the print heads; and
a replacement necessity determining mean that determines whether or not the sub-droplet collecting portion is replaced, on the basis of the amount of sub-droplets generated which has been calculated by the sub-droplet amount calculating mean.

2. The inkjet printing apparatus according to claim 1, wherein
the droplets are ejected from a plurality of ejection ports formed in each of the print heads,
the plurality of ejection ports are divided into a plurality of areas and ejection ports in the respective areas form groups of the ejection ports,
a plurality of the temperature obtaining means are mounted on the print head and in positions respectively corresponding to the groups of ejection ports, and the temperature information of the respective groups of ejection ports is obtained by the temperature obtaining means respectively corresponding to the groups of ejection ports, and
the sub-droplet amount calculating mean calculates the amount of sub-droplets generated on the basis of the printing conditions including the temperature information of each of the groups of ejection ports.

3. The inkjet printing apparatus according to claim 1, wherein
the droplets are ejected from a plurality of ejection port rows of the ejection ports arranged on each of the print head,
a plurality of the temperature obtaining means are mounted on the print head and in positions respectively corresponding to the ejection port rows, and the temperature information of the respective ejection port rows is obtained by the temperature obtaining means respectively corresponding to the ejection port rows, and
the sub-droplet amount calculating mean calculates the amount of sub-droplets generated on the basis of the printing conditions including the temperature information of each of the ejection port rows.

4. The inkjet printing apparatus according to claim 1, wherein
the print heads perform the printing while scanning in a direction perpendicular to a feeding direction of the printing medium, and
the temperature information obtained by the temperature obtaining mean uses a minimum temperature detected in one scan pass of the print heads.

5. The inkjet printing apparatus according to claim 1, wherein
the print heads perform the printing while scanning in a direction perpendicular to a feeding direction of the printing medium, and
the temperature information obtained by the temperature obtaining mean uses a maximum temperature detected in one scan pass of the print heads.

6. The inkjet printing apparatus according to claim 1, wherein
the print heads perform the printing while scanning in a direction perpendicular to a feeding direction of the printing medium, and
the temperature information obtained by the temperature obtaining mean uses an average temperature in one scan pass of the print heads.

7. The inkjet printing apparatus according to claim 1, wherein the sub-droplet amount calculating mean calculates the amount of sub-droplets generated on the basis of the printing conditions including types of ink.

8. The inkjet printing apparatus according to claim 1, wherein the sub-droplet amount calculating mean calculates the amount of sub-droplets generated on the basis of the printing conditions including a distance between the print head and the printing medium.

9. The inkjet printing apparatus according to claim 1, wherein the sub-droplet amount calculating mean calculates the amount of sub-droplets generated on the basis of the printing conditions including a collection efficiency of the sub-droplet collecting portion.

10. An inkjet printing apparatus using print heads for ejecting liquid droplets from ejection ports to a printing medium for printing, comprising:
a sub-droplet collecting portion that collects sub-droplets each having a smaller liquid volume than that of a main droplet in each of the liquid droplets produced by the ejection;
a sub-droplet amount calculating mean that calculates the amount of sub-droplets generated on the basis of printing conditions including a shape of the ejection ports of the print heads; and
a replacement necessity determining mean that determines whether or not the sub-droplet collecting portion is replaced, on the basis of the amount of sub-droplets generated which has been calculated by the sub-droplet amount calculating mean.

11. The inkjet printing apparatus according to claim 10, wherein the sub-droplet amount calculating mean calculates the amount of sub-droplets generated on the basis of the printing conditions including the amount of ink evaporation.

12. The inkjet printing apparatus according to claim 10, wherein the sub-droplet amount calculating mean calculates the amount of sub-droplets generated on the basis of the printing conditions including a distance between the print head and the printing medium.

13. The inkjet printing apparatus according to claim 10, wherein the sub-droplet amount calculating mean calculates the amount of sub-droplets generated on the basis of the printing conditions including a collection efficiency of the sub-droplet collecting portion.

14. An inkjet printing apparatus using print heads for ejecting liquid droplets to a printing medium from a plurality of ejection port rows for printing, comprising:
a sub-droplet collecting portion that collects sub-droplets each having a smaller liquid volume than that of a main droplet in each of the liquid droplets produced by the ejection;
a sub-droplet amount calculating mean that calculates the amount of sub-droplets generated on the basis of printing conditions including order of ejecting the liquid droplet from the ejection ports in the ejection port rows; and
a replacement necessity determining mean that determines whether or not the sub-droplet collecting portion is replaced, on the basis of the amount of sub-droplets generated which has been calculated by the sub-droplet amount calculating mean.

15. The inkjet printing apparatus according to claim 14, wherein
the plurality of ejection ports forming the ejection port rows are assigned to a plurality of blocks,
the liquid droplets are ejected sequentially from the ejection ports on a block basis,
the order of ejection of the liquid droplets is order of the blocks for the ejection.

16. A method of performing maintenance on an inkjet printing apparatus using print heads for ejecting liquid droplets to a printing medium for printing, comprising:
a process of collecting sub-droplets each having a smaller liquid volume than that of a main droplet in each of the liquid droplets produced by the ejection;
a temperature obtaining process for obtaining temperature information of the print heads;
a sub-droplet amount calculating process for calculating the amount of sub-droplets generated on the basis of printing conditions including the temperature information of the print heads; and
a replacement necessity determining process for determining whether or not a replacement of a sub-droplet collecting portion for collecting the sub-droplets is necessary in accordance with the amount of sub-droplets collected of the calculated sub-droplets.

17. A method of performing maintenance on an inkjet printing apparatus using print heads for ejecting liquid droplets to a printing medium from ejection ports for printing, comprising:
a process of collecting sub-droplets each having a smaller liquid volume than that of a main droplet in each of the liquid droplets produced by the ejection;
a sub-droplet amount calculating mean for calculating the amount of sub-droplets generated on the basis of printing conditions including a shape of the ejection ports of the print heads; and
a replacement necessity determining process for determining whether or not a replacement of a sub-droplet collecting portion for collecting the sub-droplets is necessary in accordance with the amount of sub-droplets collected of the calculated sub-droplets.

18. A method of performing maintenance on an inkjet printing apparatus using print heads for ejecting liquid droplets to a printing medium from ejection port rows of ejection ports for printing, comprising:
a process for collecting sub-droplets each having a smaller liquid volume than that of a main droplet in each of the liquid droplets produced by the ejection;
a sub-droplet amount calculating process for calculating the amount of sub-droplets generated on the basis of printing conditions including order of ejecting the liquid droplet from the ejection ports in the ejection port rows; and
a replacement necessity determining process for determining whether or not a replacement of a sub-droplet collecting portion for collecting the sub-droplets is necessary in accordance with the amount of sub-droplets collected of the calculated sub-droplets.

19. An inkjet printing apparatus comprising:
a print head in which a plurality of ejection ports are arranged and generating sub-droplets in accordance with main droplets, each sub-droplets having a smaller liquid volume than that of a main droplet;
a control unit for controlling the performing of printing to the print medium by controlling the ink ejection by the print head;
a drive controlling unit for dividing the ejection ports of the print head into a plurality of blocks and for ejecting ink from ejection ports of each block by driving, said drive controlling unit being capable of changing the order of the blocks for the ink ejection;
a distance detecting unit for detecting the distance between the print head and the printing medium;
a sub-droplet collecting portion mounted to the inkjet printing apparatus replaceable, for collecting the sub-droplets generated in accordance with ejecting the main droplets;
a temperature obtaining mean that obtains temperature of the print heads; and
a replacement necessity determining mean that determines whether or not the sub-droplet collecting portion is replaced on the basis of the amount of sub-droplets generated which has been calculated by the sub-droplet amount calculating mean by using the temperature obtained by the temperature obtaining mean, the distance detected by the distance detecting unit and the order of the blocks for the ink ejection set by the drive controlling unit.
